(19) United States
(12) Patent Application Publication
(10) Pub. No.: US 2026/0111428 A1
(43) Pub. Date: Apr. 23, 2026

(54) GENERATING SQL QUERIES FROM NATURAL LANGUAGE REQUESTS

(71) Applicant: Amazon Technologies, Inc., Seattle, WA (US)

(72) Inventors: Maxim Saltykov WINTER, Fair Lawn, NJ (US); Kostya BELEZKO, Vaughan (CA)

(21) Appl. No.: 18/924,684

(22) Filed: Oct. 23, 2024

(51) Int. Cl. G06F 16/2458; G06F 16/28

(52) U.S. Cl. CPC G06F 16/2458; G06F 16/285

(57) ABSTRACT

Techniques for generating SQL queries from natural language requests are described. In some examples, a method for generating a SQL query from a natural language request includes performing entity extraction on the natural language query to extract entities and predict domains; determining required tables of the relational database to answer the natural language query; generating a SQL generation ready entity relationship graph based on the determined required tables; and generating a SQL query from at least the SQL generation ready entity relationship graph.

### BACKGROUND

A relational database is a type of database with data organized into columns and rows to form tables wherein related tables share something in common. A database table is a collection of related data entries. A table may comprise columns and rows where a column holds specific information about every record in the table and a record (row) is an entry in the table.

A relational database management system (RDBMS) maintains a relational database and may use structured query language (SQL) queries to access data in the database.

One or more data definition language (DDL) files may be used to define a relational database (e.g., define a database schema). A DDL allows for the creation and modification of the structure of database objects. create, drop, alter, comment, rename, or truncate database structures, but not data.

### BRIEF DESCRIPTION OF DRAWINGS

Various examples in accordance with the present disclosure will be described with reference to the drawings, in which:

FIG. 1 illustrates examples of support for generating a SQL query from a natural language query.

FIG. 2 illustrates examples of generating an answer to a natural language question for a relational database.

FIG. 3 illustrates examples for generating a candidate table list.

FIG. 4 illustrates examples for performing a join path search on an ER graph.

FIGS. 5-8 illustrate examples of an entity relationship graph as a join path search is performed.

FIG. 9 illustrates examples of SQL query generation.

FIG. 10 is a flow diagram illustrating operations of a method for performing SQL queries from a NLQ according to some examples.

FIG. 11 is a flow diagram illustrating operations of a method for performing schema discovery according to some examples.

FIG. 12 illustrates an example cloud provider network environment according to some examples.

FIG. 13 is a block diagram of an example cloud provider network that provides a storage service and a hardware virtualization service to users according to some examples.

FIG. 14 is a block diagram illustrating an example computing device that can be used in some examples.

### DETAILED DESCRIPTION

The present disclosure relates to methods, apparatus, systems, and non-transitory computer-readable storage media for generating SQL queries from a natural language request. Generating SQL queries from a natural language request is a challenging problem, especially for large enterprise databases with thousands of tables spanning multiple schemas and databases. Traditional approaches that simply feed table definitions and metadata into a large language model make it impossible to process large schemas that exceed the maximum size of the context window. Additionally, large amounts of irrelevant metadata increases ambiguity and make it hard for the model to focus, leading to incorrect query generation. An alternative approach of starting with a small set of tables and then iteratively growing that set until a join can be completed does not scale for large schemas due to the number of iterations required, and the significant cost of failed attempts.

Detailed herein are examples for generating SQL queries for a relational database from natural language questions based on metadata from a relational database management system. Examples use an entity graph to represent and store entity and relationship metadata for the relational database (RDB) which allows efficient filtering and searching of the metadata based on entities extracted from the natural language question. By narrowing down the relevant metadata to only the portions pertaining to the entities mentioned in the question there is a reduction in noise and ambiguity when generating the SQL statements.

In some examples, entities are extracted, and database domains predicted, from the natural language question. The metadata is searched for the predicted domains and the results filtered tables and relationships matching the extracted entities. One or more subgraphs is/are constructed from the matched tables and relationships (required nodes)with missing nodes filled in that subgraph to connect those required nodes. The subgraph(s) is/are converted into a SQL query and executed against the RDB.

By representing the metadata as a flexible graph database and filtering it based on the user's question context, examples detailed herein provide more accurate and scalable natural language interface for querying databases compared to existing approaches.

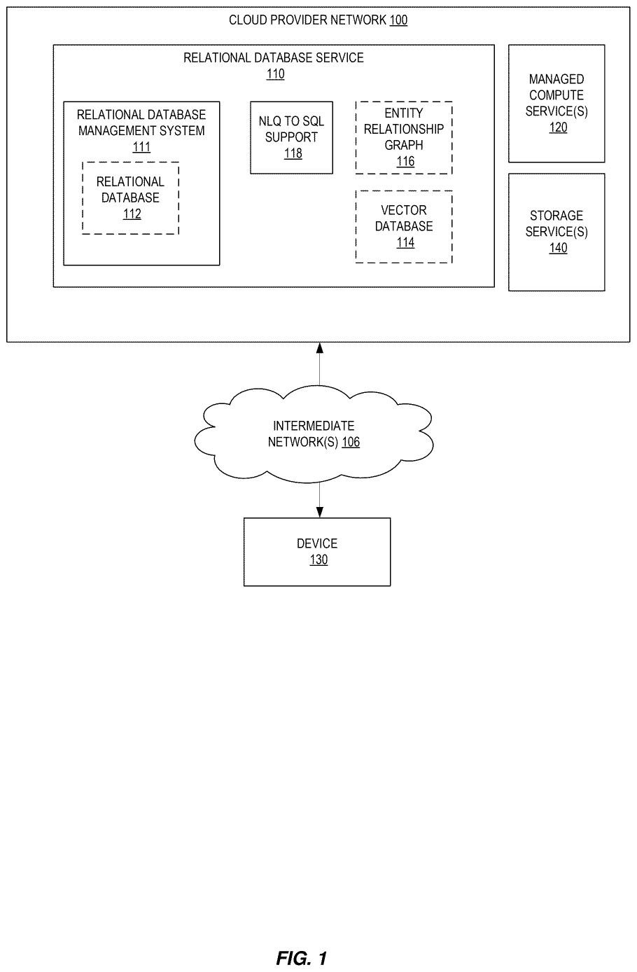

FIG. 1 illustrates examples of support for generating a SQL query from a natural language query. A service of the cloud provider network 100 is a relational database service 110. This service allows a user to maintain a relational database 112 via a relational database management system 111. Note that the relational database 112 may be stored using a storage service 140.

The relational database service 110 provides NLQ to SQL support 118 which takes in a NLQ and generates a SQL query. The NLQ to SQL support 118 may also be used to execute the SQL query using one or more of a vector database 114 storing metadata (which may be stored using a storage service 140) and an entity relationship (ER) graph that describes the relational database 112.

The relational database service 110 may support one or more relational database engines such as Db2, MariaDB, Microsoft SQL Server, MySQL, Oracle Database, and PostgreSQ, etc. The relational database service 110 also manages backups, software patching, automatic failure detection, and recovery.

A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure; for example, virtual machine instances may be concurrently hosted for different customers using a same underlying physical host computing device.

Users (e.g., via device 130) can interact with a cloud provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

Generally, the traffic and operations of a provider network can broadly be subdivided into two categories: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes user resources that are implemented on the provider network (e.g., computing instances, containers, block storage volumes, databases, file storage). Data plane traffic generally includes non-administrative operations, such as transferring user data to and from the user resources. The control plane components are typically implemented on a separate set of servers from the data plane servers, and control plane traffic and data plane traffic can be sent over separate/distinct networks.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” 120 that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the cloud provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the cloud provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

A virtual private cloud (VPC) (also referred to as a virtual network (VNet), virtual private network, or virtual cloud network, in various implementations) is a custom-defined, virtual network within another network, such as a cloud provider network. A VPC can be defined by at least its address space, internal structure (e.g., the computing resources that comprise the VPC, security groups), and transit paths, and is logically isolated from other virtual networks in the cloud. A VPC can span all of the availability zones in a particular region.

A VPC can provide the foundational network layer for a cloud service, for example a compute cloud or an edge cloud, or for a customer application or workload that runs on the cloud. A VPC can be dedicated to a particular customer account (or set of related customer accounts, such as different customer accounts belonging to the same business organization). Customers can launch resources, such as compute instances, into their VPC(s). When creating a VPC, a customer can specify a range of IP addresses for the VPC in the form of a Classless Inter-Domain Routing (CIDR) block. After creating a VPC, a customer can add one or more subnets in each availability zone or edge location associated with its region.

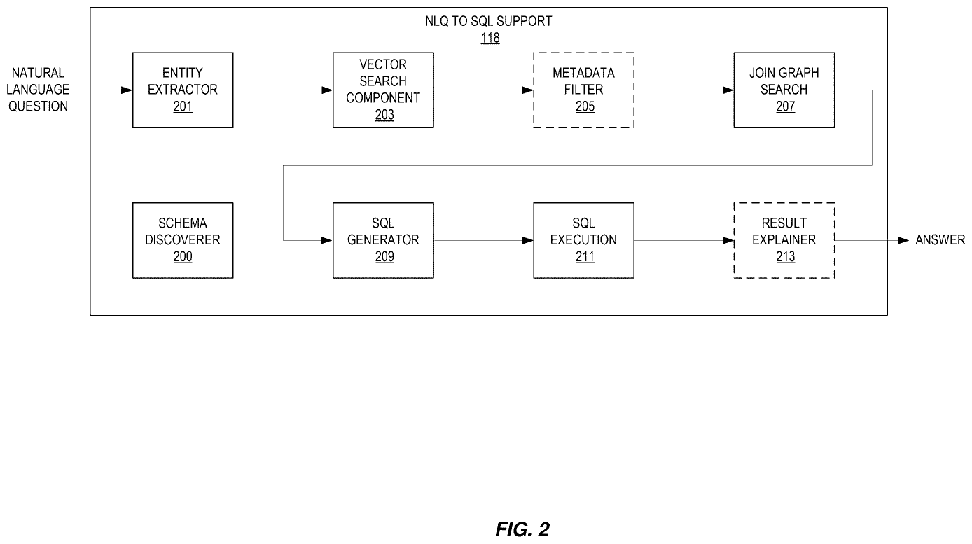

FIG. 2 illustrates examples of generating an answer to a natural language question for a relational database. In some examples, the components and/or services shown are a part of the relational database service 110 such as NLQ to SQL support 118.

In some examples, a schema discoverer 200 is used to discover or generate metadata for a relational database and/or generate an entity relationship graph.

An entity extractor 201 (e.g., a natural language processing (NLP) entity extractor) extracts entities (which may be called “entity descriptions”) from the natural language query (NLQ). In some examples, the entity extractor 201 also predicts database domains/sources from the NLQ. Examples of database domains/sources include database names that may be relevant. In some examples, the entity extractor 201 generates a disambiguated version of the NLQ. In some examples, the entity extractor 201 is one or more transformer-based machine learning model(s) such as Bidirectional Encoder Representations from Transformers (BERT) model, a generative pre-trained transformer model (e.g., a generative artificial intelligence (genAI) model such as a language model (such as a large language model (LLM)), etc. In some examples, the entity extractor 201 has access to the underlying relational database and/or metadata for the relational database.

The output of the entity extractor 201 is fed to a vector search component 203 which performs a vector search on vector database 114 to retrieve a set of distinct relevant tables that contain only schema objects associated with the predicted database domains/sources (this set may be called a “candidate table list”). The vector database 114 stores metadata regarding the relational database such as column data histograms and/or table/column/value descriptions. In some examples, the vector search component 203 is a search service provided by the cloud provider network 100. In some examples, the vector search component 203 is a component of the relational database service 110.

A metadata filter 205 uses the candidate table list (and in some examples a disambiguated NLQ) to retrieve only relevant subgraphs (required tables) from the ER graph 116 by matching table descriptions to the extracted entities and domains. Relevant subgraphs include the relevant (or required) table of the ER graph 116 and nodes that lead to the required tables. The subgraphs that are pruned (removed) are those that cannot lead to required tables and redundant path tables.

A join graph search routine 207 is performed to at least 1) filter the ER graph 116 to remove unreachable paths from the ER graph 116 and/or 2) perform path finding to add missing join tables to the filtered graph until all of the relevant subgraphs (tables) of the ER graph 116 can be connected by one SQL join. These acts help form a filtered, relevant metadata data subgraph from the ER graph 116.

A SQL generator 209 takes the filtered, relevant metadata data subgraph and the NLQ and generates a SQL command. The SQL generator 209 is a genAI model in some examples.

The SQL command is run on the relational database 112 at SQL execution 211 to generate a SQL result. In some examples, this result is provided to the requesting user.

The SQL result, in some examples, is input into a result explainer 213 to generate a natural language answer for the NLQ.

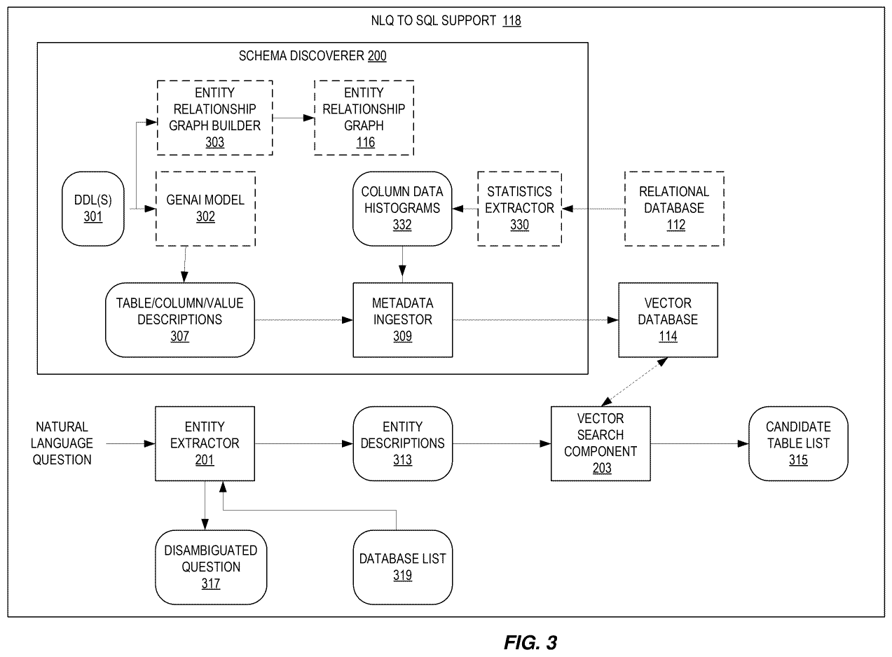

FIG. 3 illustrates examples for generating a candidate table list. This illustration shows the schema discovery process that is performed by a schema discoverer 200. In some examples, table/column/value descriptions 307 of an RDBMS schema (e.g., comments) are ingested using a metadata ingestor 309. In some examples, table/column/value descriptions 307 are predicted from one or more DDL(s) 301 using a genAI model 302. The histograms 305 and/or table/column/value descriptions 307 are vectorized and stored in a vector database 114.

In some examples, an entity relationship graph builder 303 generates an entity relationship graph 116 from the one or more DDL(s) 301.

As shown and detailed above, the entity extractor 201 generates entity descriptions 313 and a disambiguated question 317 from a natural language question and a source/database list 319. The entity descriptions 313 and source/database list 319 are input to the vector search component 203 which searches the vector database 114 for a candidate table list 315. In some examples, the results of the vector database 114 search are re-ranked to narrow the list of candidates (e.g., lower ranked candidates are thrown out).

A statistics extractor 330 generates column data histograms 332 from the relational database 112. In some examples, the column data histograms 332 are ingested by the metadata ingestor 309. Note that histograms represent actual data.

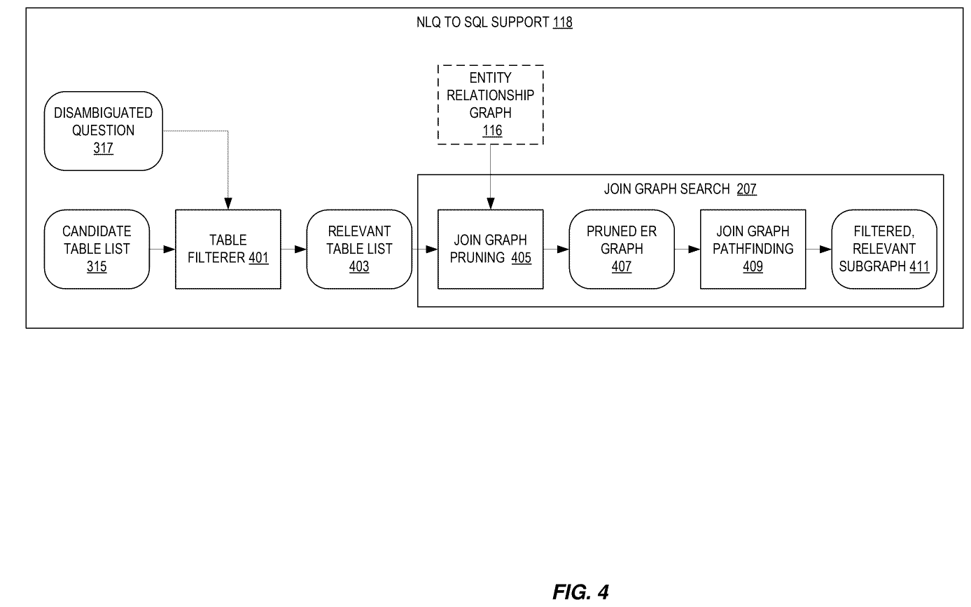

FIG. 4 illustrates examples for performing a join path search 207 on an ER graph. The candidate table list 315 and disambiguated question 317 are input to a table filterer 401. This filter generates a relevant table list 403. This list may also be called a “required table list.” In some examples, a genAI model is used to generate the relevant table list.

The ER graph 116 is pruned using the relevant table list 403 by performing join graph pruning 405. In some examples, the ER graph is pruned to form a pruned ER graph 407 by removing tables that cannot lead to the required tables and removing redundant path tables. In some examples, the removals are iterative.

A join graph pathfinding 409 is performed on the pruned ER graph 407 to find a minimal subgraph that connects all of the required tables shown as filtered, relevant subgraph 411. In some examples, a best-first search is performed to find the minimal subgraph connecting all required tables. The filtered, relevant subgraph 411 containing only the most relevant tables and relationships. In some examples, a minimal subgraph is a convex graph such that a set of vertices S in a graph is convex if it contains all vertices which belong to shortest paths between vertices in S. In some examples, a minimal subgraph is determined by one or more of weights and/or edge lengths of paths.

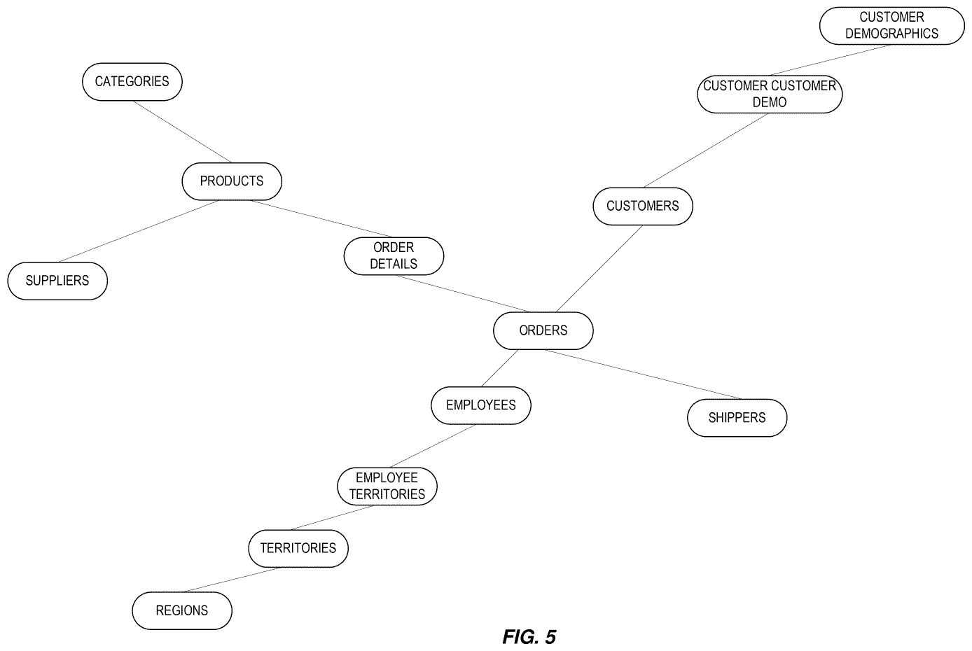

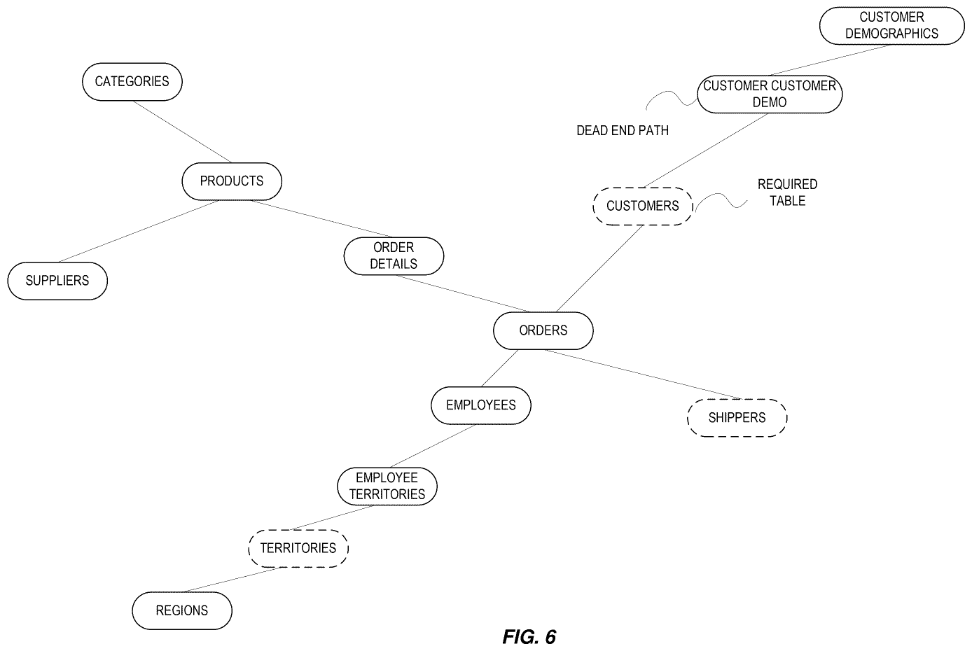

FIGS. 5-8 illustrate examples of an entity relationship graph as a join path search is performed. FIG. 5 illustrates examples of an entity relationship graph after a vector search has been performed. FIG. 6 illustrates examples of the entity relationship graph of FIG. 5 where required tables are highlighted. In particular, the entities in dashed boxes are required. Nodes of the graph that go beyond a required table are dead ends.

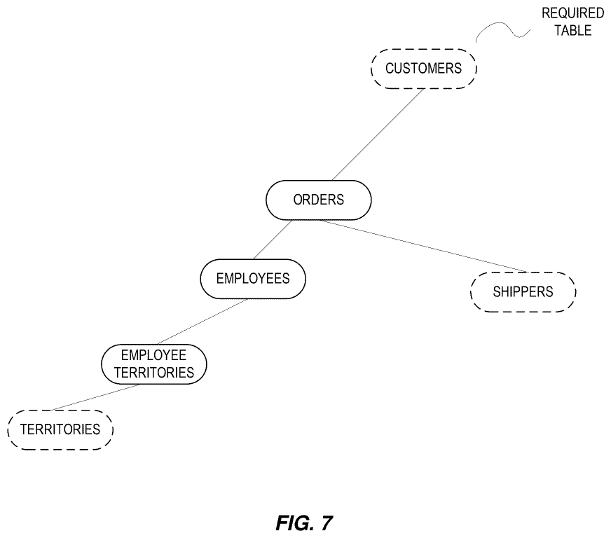

FIG. 7 illustrates examples of the entity relationship graph of FIG. 5 where dead end paths are removed. The paths that are removed do not end in a required entity. Note that the entities orders, employees, and employee territories are still in the graph as they are a part of a path to a required entity. This is an example of the pruned ER graph 407.

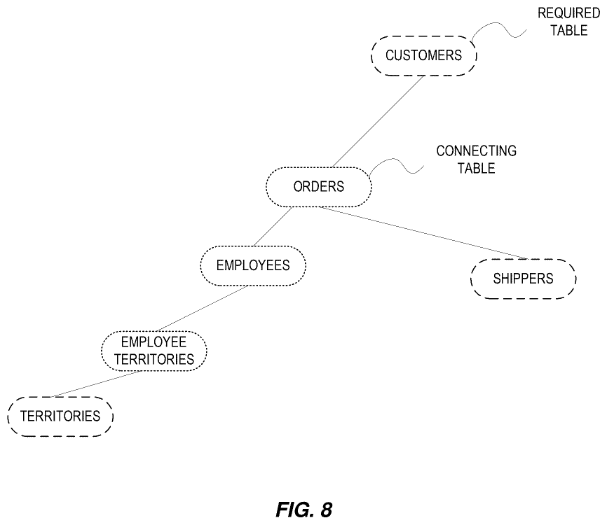

FIG. 8 illustrates examples of the entity relationship graph of FIG. 5 where connecting tables are added to the pruned ER graph. In this example, orders, employees, and employee territories are marked as connecting tables to the required entities. This forms a filtered, relevant subgraph (e.g., an example of filtered, relevant subgraph 411).

This filtered, relevant subgraph 411 is passed to the SQL generator 209 which converts the filtered, relevant subgraph 411 and NLQ into a SQL command.

In some examples, the SQL command can be refined by allowing a human to have input on one or more of the ER graph (with changes such as additions and/or corrects synced to the ER graph) and/or the SQL command.

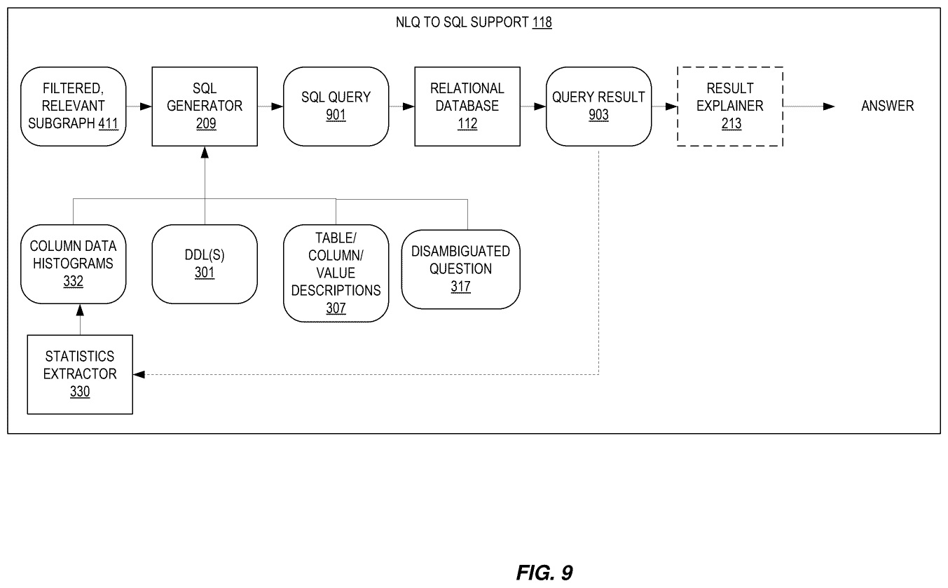

FIG. 9 illustrates examples of SQL query generation. In some examples, this is a part of NLQ to SQL support 118. A SQL query is predicted using a SQL generator (e.g., a genAI model) from the minimal join path table set (e.g., filtered, relevant subgraph 411) and input metadata (e.g., column/data histograms 905, table/column/value descriptions 307, and/or DDL(s) 301. As shown, a statistics extractor 330 generates column data histograms 332 from the relational database 112.

The predicted SQL query 901 is used to query the relational database 112 to produce a query result 903. In some examples, a result explainer 213 is used to generate a natural language answer. In some examples, the query result 903 is used to update column data histograms 332.

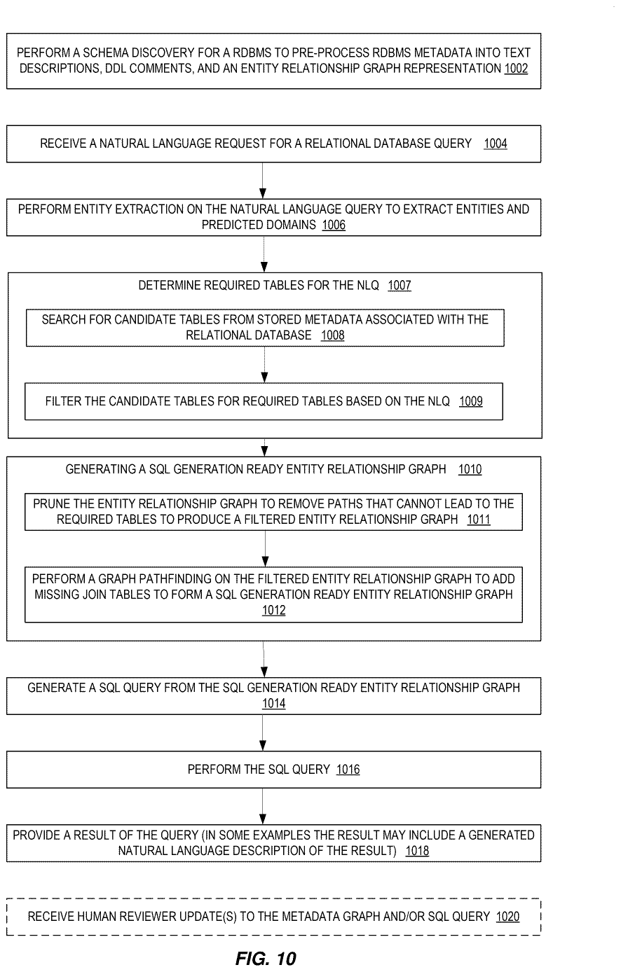

FIG. 10 is a flow diagram illustrating operations of a method for performing SQL queries from a NLQ according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by at least a relational database service 110 of the other figures.

In some examples, schema discovery is performed for a RDB to pre-process the schema of the RDB (as supported by a RDBS) into metadata such as table/column/value descriptions to be stored in a vector database and generate an entity relationship graph representation at 1002.

A natural language request for a relational database query is received at 1004. The NLQ request may include a question, an indication of which relational database to query against, etc.

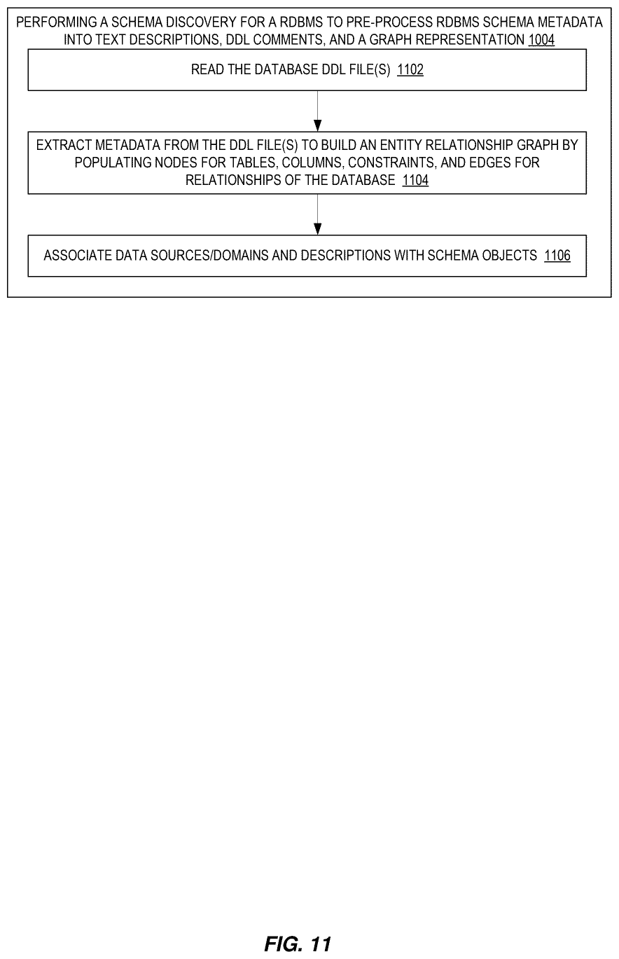

FIG. 11 is a flow diagram illustrating operations of a method for performing schema discovery according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by at least a relational database service 110 of the other figures.

The DDL files of the RDBMS are read at 1102.

Metadata is extracted from the DDL file(s) to build an entity relationship graph by populating nodes for tables, columns, constraints, and edges for relationships of the database at 1104. In some examples, genAI model is used to build the entity relationship graph. In some examples, an entity relationship graph builder 303 is used to build the entity relationship graph. In some examples, the entity relationship graph builder 303 is supplied by the RDBMS.

Data sources/domains and table/column/value descriptions are associated with the nodes at 1106. In some examples, the table/column/value descriptions are comments in the DDL file(s). In some examples, the table/column/value descriptions are generated from the DDL file(s) by a genAI model.

Entity extraction is performed on the natural language query to extract entities and predict domains at 1006.

A determination of required tables to answer the NLQ is made at 1007. In some examples, the metadata is searched for candidate tables that match the extracted entities and predicted domains (e.g., by performing a vector search) at 1008. The candidate tables are filtered at 1009 based on the NLQ to determine required tables. In some examples, a disambiguated variant of the NLQ forms the basis for the candidate table filtering. In some examples, the vector search performs the filtering to the required tables (and no candidate tables are found).

A SQL generation ready entity relationship graph is generated at 1010.

The entity relationship graph is pruned to remove paths that cannot lead to the required tables to produce a filtered entity relationship graph at 1011.

Graph pathfinding on the filtered entity relationship graph to add missing join tables is performed to form a SQL generation ready entity relationship graph at 1012. In some examples, the adding of missing join tables seeks to connect all required tables using the minimum number of additional tables using a pathfinding search. In some examples, a priority queue of partial paths is maintained during the search that is prioritized by the number of required tables a partial path connects and a total length of the partial path. In some examples, the pathfinding search explores in multiple directions simultaneously, seeking to connect all required tables. A prospective path is not abandoned until all directions from all its nodes have been explored. This best-first approach allows the pathfinding search algorithm to quickly identify promising paths and explore those paths first, improving efficiency. Once the path finding search finds a path that connects all required tables, it extracts the minimal subgraph containing these tables and the intermediate tables and relationships needed to join them.

A SQL query from the SQL generation ready entity relationship graph is generated at 1014.

The SQL query is performed against the relationship database at 1016.

A result of the query provided at 1018. In some examples, a genAI model is used to explain the result.

In some examples, human reviewer update(s) to the ER graph and/or SQL query are received at 1020. These update(s) may be used to re-generate and run a modified SQL query.

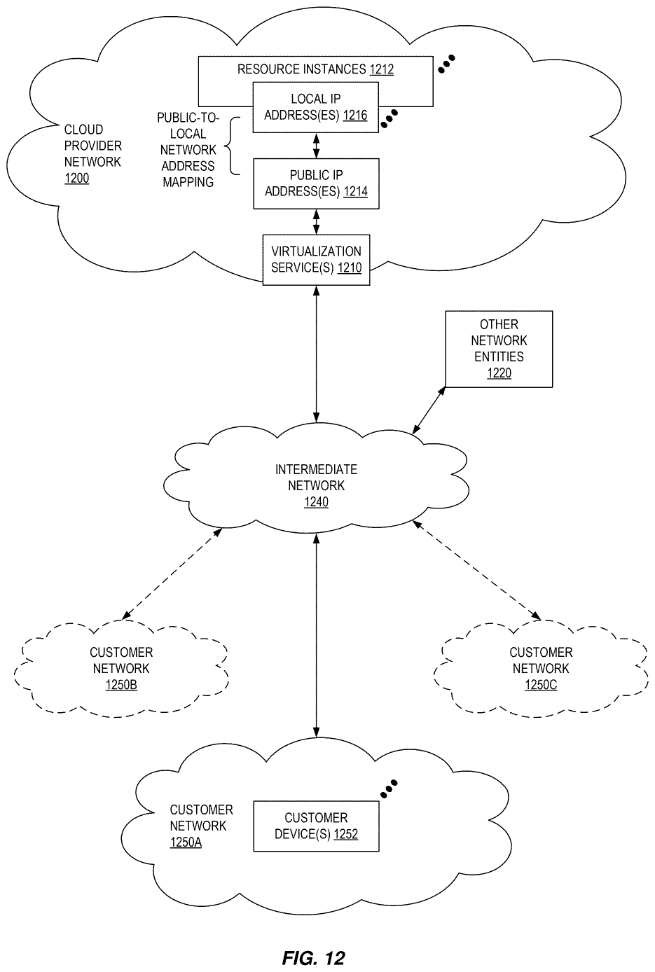

FIG. 12 illustrates an example provider network (or “service provider system”) environment according to some examples. A provider network 1200 can provide resource virtualization to customers via one or more virtualization services 1210 that allow customers to purchase, rent, or otherwise obtain instances 1212 of virtualized resources, including but not limited to computation and storage resources, implemented on devices within the provider network or networks in one or more data centers. Local Internet Protocol (IP) addresses 1216 can be associated with the resource instances 1212; the local IP addresses are the internal network addresses of the resource instances 1212 on the provider network 1200. In some examples, the provider network 1200 can also provide public IP addresses 1214 and/or public IP address ranges (e.g., Internet Protocol version 4 (IPv4) or Internet Protocol version 6 (IPv6) addresses) that customers can obtain from the provider network 1200.

Conventionally, the provider network 1200, via the virtualization services 1210, can allow a customer of the service provider (e.g., a customer that operates one or more customer networks 1250A-1250C (or “client networks”) including one or more customer device(s) 1252) to dynamically associate at least some public IP addresses 1214 assigned or allocated to the customer with particular resource instances 1212 assigned to the customer. The provider network 1200 can also allow the customer to remap a public IP address 1214, previously mapped to one virtualized computing resource instance 1212 allocated to the customer, to another virtualized computing resource instance 1212 that is also allocated to the customer. Using the virtualized computing resource instances 1212 and public IP addresses 1214 provided by the service provider, a customer of the service provider such as the operator of the customer network(s) 1250A-1250C can, for example, implement customer-specific applications and present the customer's applications on an intermediate network 1240, such as the Internet. Other network entities 1220 on the intermediate network 1240 can then generate traffic to a destination public IP address 1214 published by the customer network(s) 1250A-1250C; the traffic is routed to the service provider data center, and at the data center is routed, via a network substrate, to the local IP address 1216 of the virtualized computing resource instance 1212 currently mapped to the destination public IP address 1214. Similarly, response traffic from the virtualized computing resource instance 1212 can be routed via the network substrate back onto the intermediate network 1240 to the source entity 1220.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 1200; a customer can then assign their allocated public IP addresses to particular resource instances allocated to the customer. These public IP addresses can be referred to as customer public IP addresses, or simply customer IP addresses. Instead of being assigned by the provider network 1200 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

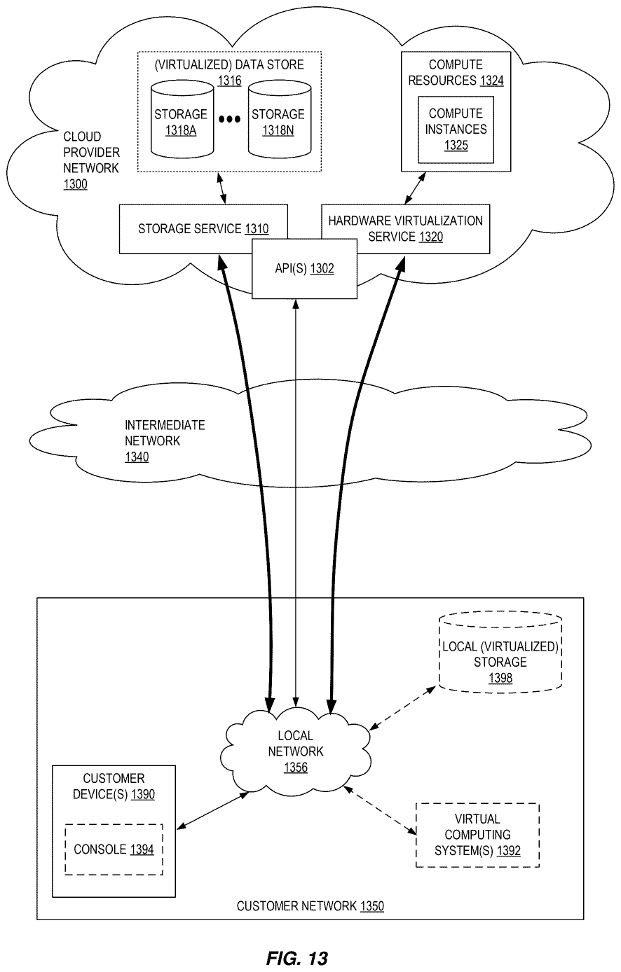

FIG. 13 is a block diagram of an example provider network environment that provides a storage service and a hardware virtualization service to users, according to some examples. A hardware virtualization service 1320 provides multiple compute resources 1324 (e.g., compute instances 1325, such as VMs) to users. The compute resources 1324 can, for example, be provided as a service to users (or “customers”) of a provider network 1300 (e.g., to a customer that implements a customer network 1350). Each computation resource 1324 can be provided with one or more local IP addresses. The provider network 1300 can be configured to route packets from the local IP addresses of the compute resources 1324 to public Internet destinations, and from public Internet sources to the local IP addresses of the compute resources 1324.

The provider network 1300 can provide the customer network 1350, for example coupled to an intermediate network 1340 via a local network 1356, the ability to implement virtual computing systems 1392 via the hardware virtualization service 1320 coupled to the intermediate network 1340 and to the provider network 1300. In some examples, the hardware virtualization service 1320 can provide one or more APIs 1302, for example a web services interface, via which the customer network 1350 can access functionality provided by the hardware virtualization service 1320, for example via a console 1394 (e.g., a web-based application, standalone application, mobile application, etc.) of a customer device 1390. In some examples, at the provider network 1300, each virtual computing system 1392 at the customer network 1350 can correspond to a computation resource 1324 that is leased, rented, or otherwise provided to the customer network 1350.

From an instance of the virtual computing system(s) 1392 and/or another customer device 1390 (e.g., via console 1394), the customer can access the functionality of a storage service 1310, for example via the one or more APIs 1302, to access data from and store data to storage resources 1318A-1318N of a virtual data store 1316 (e.g., a folder or “bucket,” a virtualized volume, a database, etc.) provided by the provider network 1300. In some examples, a virtualized data store gateway (not shown) can be provided at the customer network 1350 that can locally cache at least some data, for example frequently accessed or critical data, and that can communicate with the storage service 1310 via one or more communications channels to upload new or modified data from a local cache so that the primary store of data (the virtualized data store 1316) is maintained. In some examples, a user, via the virtual computing system 1392 and/or another customer device 1390, can mount and access virtual data store 1316 volumes via the storage service 1310 acting as a storage virtualization service, and these volumes can appear to the user as local (virtualized) storage 1398.

While not shown in FIG. 13, the virtualization service(s) can also be accessed from resource instances within the provider network 1300 via the API(s) 1302. For example, a customer, appliance service provider, or other entity can access a virtualization service from within a respective virtual network on the provider network 1300 via the API(s) 1302 to request allocation of one or more resource instances within the virtual network or within another virtual network.

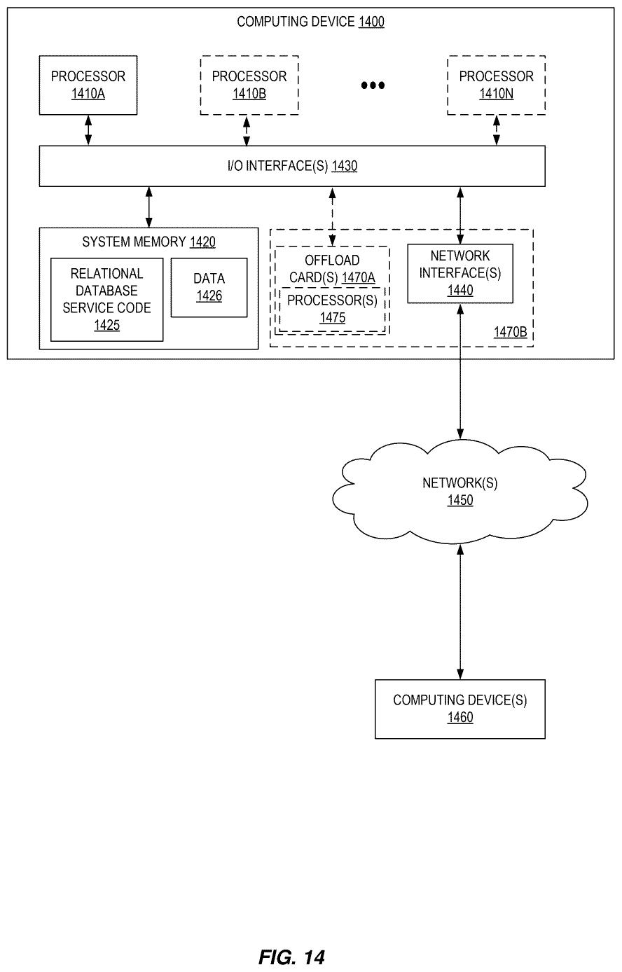

Illustrative Systems In some examples, a system that implements a portion or all of the techniques described herein can include a general-purpose computer system, such as the computing device 1400 (also referred to as a computing system or electronic device) illustrated in FIG. 14, that includes, or is configured to access, one or more computer-accessible media. In the illustrated example, the computing device 1400 includes one or more processors 1410 coupled to a system memory 1420 via an input/output (I/O) interface 1430. The computing device 1400 further includes a network interface 1440 coupled to the I/O interface 1430. While FIG. 14 shows the computing device 1400 as a single computing device, in various examples the computing device 1400 can include one computing device or any number of computing devices configured to work together as a single computing device 1400.

In various examples, the computing device 1400 can be a uniprocessor system including one processor 1410, or a multiprocessor system including several processors 1410 (e.g., two, four, eight, or another suitable number). The processor(s) 1410 can be any suitable processor(s) capable of executing instructions. For example, in various examples, the processor(s) 1410 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1410 can commonly, but not necessarily, implement the same ISA.

The system memory 1420 can store instructions and data accessible by the processor(s) 1410. In various examples, the system memory 1420 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1420 as relational database service code 1425 (e.g., executable to implement, in whole or in part, the relational database service 110) and data 1426.

In some examples, the I/O interface 1430 can be configured to coordinate I/O traffic between the processor 1410, the system memory 1420, and any peripheral devices in the device, including the network interface 1440 and/or other peripheral interfaces (not shown). In some examples, the I/O interface 1430 can perform any necessary protocol, timing, or other data transformations to convert data signals from one component (e.g., the system memory 1420) into a format suitable for use by another component (e.g., the processor 1410). In some examples, the I/O interface 1430 can include support for devices attached through various types of peripheral buses, such as a variant of the Peripheral Component Interconnect (PCI) bus standard or the Universal Serial Bus (USB) standard, for example. In some examples, the function of the I/O interface 1430 can be split into two or more separate components, such as a north bridge and a south bridge, for example. Also, in some examples, some or all of the functionality of the I/O interface 1430, such as an interface to the system memory 1420, can be incorporated directly into the processor 1410.

The network interface 1440 can be configured to allow data to be exchanged between the computing device 1400 and other computing devices 1460 attached to a network or networks 1450, such as other computer systems or devices as illustrated in FIG. 1, for example. In various examples, the network interface 1440 can support communication via any suitable wired or wireless general data networks, such as types of Ethernet network, for example. Additionally, the network interface 1440 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 1400 includes one or more offload cards 1470A or 1470B (including one or more processors 1475, and possibly including the one or more network interfaces 1440) that are connected using the I/O interface 1430 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 1400 can act as a host electronic device (e.g., operating as part of a hardware virtualization service) that hosts compute resources such as compute instances, and the one or more offload cards 1470A or 1470B execute a virtualization manager that can manage compute instances that execute on the host electronic device. As an example, in some examples the offload card(s) 1470A or 1470B can perform compute instance management operations, such as pausing and/or un-pausing compute instances, launching and/or terminating compute instances, performing memory transfer/copying operations, etc. These management operations can, in some examples, be performed by the offload card(s) 1470A or 1470B in coordination with a hypervisor (e.g., upon a request from a hypervisor) that is executed by the other processors 1410A-1410N of the computing device 1400. However, in some examples the virtualization manager implemented by the offload card(s) 1470A or 1470B can accommodate requests from other entities (e.g., from compute instances themselves), and cannot coordinate with (or service) any separate hypervisor.

In some examples, the system memory 1420 can be one example of a computer-accessible medium configured to store program instructions and data as described above. However, in other examples, program instructions and/or data can be received, sent, or stored upon different types of computer-accessible media. Generally, a computer-accessible medium can include any non-transitory storage media or memory media such as magnetic or optical media, e.g., disk or DVD/CD coupled to the computing device 1400 via the I/O interface 1430. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 1400 as the system memory 1420 or another type of memory. Further, a computer-accessible medium can include transmission media or signals such as electrical, electromagnetic, or digital signals, conveyed via a communication medium such as a network and/or a wireless link, such as can be implemented via the network interface 1440.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1318A-1318N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

1. A computer-implemented method comprising:
receiving a natural language query (NLQ) for a relational database, wherein the NLQ includes a question and an indication of the relational database;
performing entity extraction on the NLQ to extract entities and predict domains;
determining required tables of the relational database to answer the NLQ based, at least in part, on a filtered search of metadata associated with the relational database;
generating a metadata data subgraph based on the required tables by:
generating a pruned entity relationship (ER) graph by pruning an ER graph for the relational database by removing paths that do not end in any of the required tables, and
performing join graph pathfinding on the pruned ER graph to add missing join tables to the pruned ER graph until all relevant subgraphs of the ER graph can be connected by one SQL join to form the metadata data subgraph;
generating a structured query language (SQL) query from the metadata data subgraph and the NLQ;
performing the SQL query on the relational database to generate a result; and
providing the result of the SQL query.

2. The computer-implemented method of claim 1, processing a schema of the relational database to generate the entity relationship graph for the relational database and the metadata associated with the relational database including table/column/value descriptions.

3. The computer-implemented method of claim 1, wherein the result of the SQL query comprises an explanation generated by a generative artificial intelligence model.

4. A computer-implemented method comprising:
receiving a natural language query (NLQ) for a relational database;
performing entity extraction on the NLQ to extract entities and predict domains;
determining required tables of the relational database to answer the NLQ;
generating a metadata data subgraph based on the required tables by:
generating a pruned entity relationship (ER) graph by pruning an ER graph for the relational database by removing paths that do not end in any of the required tables, and
performing join graph pathfinding on the pruned ER graph to add missing join tables to the pruned ER graph until all relevant subgraphs of the ER graph can be connected by one SQL join to form the metadata data subgraph;
generating a structured query language (SQL) query from the metadata data subgraph and the NLQ;
performing the SQL query on the relational database to generate a result; and
providing the result of the SQL query.

5. The computer-implemented method of claim 4, further comprising processing a schema of the relational database to generate the ER graph for the relational database and metadata associated with the relational database including table/column/value descriptions.

6. The computer-implemented method of claim 5, wherein the metadata associated with the relational database including table/column descriptions and metadata about values stored in each column is extracted from one or more data definition files (DDLs) of a relational database management system.

7. The computer-implemented method of claim 4, wherein providing the result of the SQL query comprises generating an explanation using a generative artificial intelligence model.

8. The computer-implemented method of claim 4, further comprising receiving one or more updates to the ER graph.

9. The computer-implemented method of claim 4, wherein determining required tables of the relational database to answer the NLQ comprises:
searching for candidate tables from stored metadata associated with the relational database including table/column descriptions; and
filtering the candidate tables based on the NLQ to determine the required tables of the relational database to answer the NLQ.

10. The computer-implemented method of claim 9, wherein the table/column descriptions are stored in a vector database.

11. (canceled)

12. The computer-implemented method of claim 4, wherein performing join graph pathfinding on the pruned ER graph to add missing join tables to the pruned ER graph until all relevant subgraphs of the ER graph can be connected by one SQL join to form the metadata data subgraph comprises finding paths that connect all required tables using a minimum number of additional tables.

13. The computer-implemented method of claim 4, wherein performing join graph pathfinding on the pruned ER graph to add missing join tables to the pruned ER graph until all relevant subgraphs of the ER graph can be connected by one SQL join to form the metadata data subgraph comprises:
exploring paths in multiple directions to connect all the required tables, wherein a prospective path is not abandoned until all directions from all its nodes have been explored; and
extracting a minimal subgraph containing the required tables and intermediate tables and relationships needed to join them.

14. The computer-implemented method of claim 4, wherein a generative artificial intelligence model performs the entity extraction on the NLQ to extract entities and predict domains.

15. The computer-implemented method of claim 4, wherein generating a SQL query from the metadata data subgraph and the NLQ further uses a disambiguated version of the NLQ and one or more of column data histograms, a data definition language file, or table/column/value descriptions.

16. A system comprising:
a first one or more computing devices to implement a data storage service in a multi-tenant provider network; and
a second one or more computing devices to implement a relational database service in the multi-tenant provider network, the relational database service including instructions that upon execution cause the relational database service to:
receive a natural language query (NLQ) for a relational database, wherein the relational database is related to data stored in the data storage service;
perform entity extraction on the NLQ to extract entities and predict domains;
determine required tables of the relational database to answer the natural language query NLQ;
generate a metadata data subgraph based on the required tables by:
generating a pruned entity relationship (ER) graph by pruning an ER graph for the relational database by removing paths that do not end in any of the required tables, and
performing join graph pathfinding on the pruned ER graph to add missing join tables to the pruned ER graph until all relevant subgraphs of the ER graph can be connected by one SQL join to form the metadata data subgraph;
generate a structured query language (SQL) query from at least the metadata data subgraph and the NLQ;
perform the SQL query on the relational database to generate a result; and
provide the result of the SQL query.

17. The system of claim 16, wherein the relational database service is further to process a schema of the relational database to generate the ER graph for the relational database and metadata associated with the relational database including table/column/value descriptions.

18. The system of claim 17, wherein to generate a SQL query from at least the metadata data subgraph and the NLQ the relational database service is to further use a disambiguated version of the NLQ and one or more of column data histograms, a data definition language file, or table/column descriptions.

19. The system of claim 16, wherein to provide the result of the SQL query comprises generating an explanation using a generative artificial intelligence model.

20. The system of claim 16, wherein a generative artificial intelligence model performs the entity extraction on the NLQ to extract entities and predict domains.

21. The system of claim 16, wherein to determine required tables of the relational database to answer the NLQ the relational database service is further to:
search for candidate tables from stored metadata associated with the relational database including table/column descriptions; and
filter the candidate tables based on the NLQ to determine the required tables of the relational database to answer the NLQ.
